(19) United States
(12) Patent Application Publication
(10) Pub. No.: US 2007/0102409 A1
(43) Pub. Date: May 10, 2007

(54) PULSED ARC WELDING METHOD

(75) Inventors: Fusaki Koshiishi, Fujisawa-shi (JP); Keiichi Suzuki, Fujisawa-shi (JP); Kei Yamazaki, Fujisawa-shi (JP); Masahiro Honma, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/470,949

(22) Filed: Sep. 7, 2006

(30) Foreign Application Priority Data
Nov. 8, 2005 (JP) 2005-324073

(51) Int. Cl. B23K 9/09

(52) U.S. Cl. 219/130.51; 219/137 PS

(57) ABSTRACT

In a pulsed arc welding method of the invention, a shield gas made mainly of carbon dioxide gas is used, and a low frequency pulse of 30 to 100 Hz is continuously generated, on which a high frequency pulse with a pulse frequency of 500 to 2000 Hz is superimposed. In this case, the welding current is determined such that an average peak current IP_{avg} is at 300 to 700 A, an average base time T_{b} is at 5 to 30 ms, a current amplitude IP-ₐ at a peak time of a high frequency pulse is at 50 to 600 A, and a current amplitude IP_{b} at a base time of a high frequency pulse is at 20 to 200 A. This method ensures a reduced degree of biasing of a drop and an arc, for which the size, release time and release direction of a drop are kept substantially completely constant, and can achieve drop transfer wherein regularity of one pulse group-one drop transfer is very high. Hence, spatter and fume generation rates can be remarkably reduced.

### TECHNICAL FIELD

This invention relates to a pulsed arc welding method using, as a shield gas, carbon dioxide gas alone or a mixed gas containing a carbon dioxide gas as a main component and more particularly, to a pulsed arc welding method in which drop transfer is realized in synchronism with a group of pulses to stabilize a welding arc and, at the same time, spatter and fume generation rates can be significantly reduced.

### TECHNICAL BACKGROUND

The MAG welding method using, as a shield gas, a mixed gas of Ar and 5 to 30% of CO₂ is able to reduce spatter and fume generation rates owing to the fine particulation of a drop, for which the method has been applied to a wide variety of fields in the past. Especially, in the field where high quality welding is required, the pulsed MAG welding method wherein one pulse-one drop transfer is performed by outputting a welding current of about 200 to 350 Hz as a pulse current has now been in wide applications.

However, since Ar gas is more expensive than carbon dioxide gas, carbon dioxide gas alone or a mixed gas made mainly of carbon dioxide gas has been frequently used as a shield gas for carrying out ordinary welding operations.

On the other hand, where carbon dioxide gas alone or a mixed gas made mainly of carbon dioxide gas is used as a shield gas, the resulting drop is rendered coarse in size to an extent of about 10 times larger over the case of the MAG welding method and is irregularly vibrated and deformed by the action of the arc force. This undesirably leads to the problems in that short-circuiting with a base metal and arc breakage are liable to occur, drop transfer becomes irregular, and spatter and fume frequently occur.

To cope with these problems, Japanese Laid-open Patent Application Nos. Hei 7-47473 and Hei 7-290241 propose a method wherein when pulsed welding is applied to in carbon dioxide gas shield arc welding under conditions where pulse parameters and welding wire components are properly defined, one pulse-one drop transfer is realized in the carbon dioxide gas arc welding. This method is one wherein a drop of a satisfactory size is formed at a wire tip prior to application of a peak current so that an electromagnetic pinch force of the peak current causes the drop to be constricted at an early stage, thereby permitting the drop to be released from the wire before the drop would be forced back toward the wire direction by the arc force.

With respect to the above welding method, Japanese Laid-open Patent Application No. Hei 8-267238 has proposed a welding method wherein external switching control for characteristics is performed for output control of an electric supply for welding, thereby achieving a further reduction of spatter.

Further, Japanese Laid-open Patent Application No. 2003-236668 relates to an arc welding method using a shield gas made mainly of carbon dioxide gas, wherein it is stated that generation of seven or more pulses within one drop transfer time contributes to reducing spatter and weld fume.

Although all of the methods described in the above Japanese Laid-open Patent Application Nos. Hei 7-47473, Hei 7-290241 and Hei 8-267238 make use of inexpensive carbon dioxide gas as a shield gas, one pulse-one drop transfer is enabled and regularity of the drop transfer is improved. At the same time, a spatter generation rate can be reduced over pulse-free welding. In this connection, however, since carbon dioxide gas is used as a shield gas, the drop formed at the wire tip is not stable with respect to the shape thereof, so that both the drop and arc are unlikely to be axially symmetric, and are inclined in most cases. The magnitude and direction of an electromagnetic pinch force that acts to release a drop owing to the deviations of the drop and arc differ in every release timing and thus, the sizes of individual drops and release timings and directions are not fully in coincidence with each other, respectively. Eventually, a drop that cannot be transferred by one pulse may result in short-circuiting at a base period or may be transferred in a next pulse peak time, with the attendant problem that regularity of drop transfer is disturbed, thereby increasing spatter.

In the method of Japanese Laid-open Patent Application No. 2003-236668, it is stated that when seven or more pulses are generated within one drop transfer time, drops can be made small in size. Nevertheless, because a gas made mainly of carbon dioxide gas is used as a shield gas in this method, the size of a drop is as large as not less than 10 times the size of a drop in the MAG pulse welding, with the effect being not so significant. The drop transfer is complicatedly interrelated with the size of a drop, the electromagnetic pinch force of a peak time, a push-up force resulting from an arc force, a convection and vibrations inside the drop ascribed to the just-mentioned factors, and the like. The release timing is determined through the balance of a force acting along a release direction of the drop, so that the release time differs in every release timing only if such simple high frequency pulses as in this method are continuously applied to, and the intervals of the drop transfer vary within a range of about 15 to 25 milliseconds, thus not leading to a significant reduction of spatter.

Because a high frequency pulse is applied to in this method so as to ensure smooth drop transfer and thus, a peak current, base current and pulse width are, respectively, fixed, a frequency has to be modulated for the purpose of controlling an arc length at a given level in case where the distance between a chip and a base metal is varied. More particularly, in order to control a wire melting rate, a pulse frequency has to be greatly changed, thereby causing regularity of drop transfer to be disturbed. Accordingly, where the distance between a chip and a base metal varies within about ±5 mm from a standard condition, a difficulty is involved in keeping a stable arc.

### SUMMARY OF THE INVENTION

Therefore, an object of the invention is to provide a pulsed arc welding method wherein when using a shield gas made mainly of carbon dioxide gas, the drop and arc, respectively, suffer a reduced degree of deviation and the sizes, release timings and release directions of drops are kept substantially completely constant, respectively, and at the same time, drop transfer, in which regularity of one pulse group-one drop transfer is kept very high, can be achieved, and wherein spatter and fume generation rates can be significantly reduced.

Another object of the invention is to provide a pulsed arc welding method wherein even if the distance between a chip and a base metal varies, an arc length can be controlled at a given level by controlling pulse parameters within ranges where one pulse group-one drop transfer is not disturbed.

According to the invention, there is provided a pulsed arc welding method wherein carbon dioxide gas or a mixed gas made mainly of carbon dioxide gas as a shield gas, and a low frequency pulse of 30 to 100 Hz is continuously generated while superimposing a high frequency pulse with a pulse frequency ranging from 500 to 2000 Hz on the low frequency pulse, and the following welding parameter conditions (a) to (h) are satisfied:
(a) average peak current IP_{avg}=300 to 700 A;
(b) average base current IB_{avg}=50 to 300 A;
(c) pulse peak time Tₚ=3 to 25 ms;
(d) base time T_{b}=5 to 30 ms;
(e) pulse frequency F_{low} of a low frequency pulse=30 to 100 Hz;
(f) pulse frequency F_{high} of a high frequency pulse=500 to 2000 Hz;
(g) current amplitude IPₐ at a peak time of a high frequency pulse=50 to 600 A; and
(h) current amplitude IBₐ at a base time of a high frequency pulse=20 to 200 A.

In the practice of the invention, it is preferred to further satisfy the following welding parameter conditions (i) to (m):
(i) average peak current IP_{avg}=400 to 600 A;
(j) pulse peak time Tₚ=5 to 15 ms;
(k) base time T_{b}=5 to 15 ms;
(l) pulse frequency F_{low} of a low frequency pulse=30 to 70 Hz; and
(m) pulse frequency F_{high} of a high frequency pulse=800 to 1500 Hz.

In the present invention, a consuming electrode wire made of not more than 0.1 wt % of C, 0.20 to 1.0 wt % of Si, 0.5 to 2.0 wt % of Mn, and 0.05 to 0.40 wt %, in total, of Ti+Al+Zr with the balance being Fe and inevitable impurities can be used.

Further, a consuming electrode wire not plated with copper on the wire surfaces may also be used.

In the arc welding of a consuming electrode type according to the invention wherein carbon dioxide gas alone or a mixed gas made mainly of carbon dioxide gas is used, one pulse group-one drop transfer can be achieved in a very highly reproducible fashion. On comparison with prior art methods, stabilization of a welding arc and transfer regularity of a drop can be improved thereover, and spatter and fume generation rates can be remarkably reduced.

If the distance between a chip and a base metal varies, an arc length can be readily kept at a given level by feeding back variations in voltage and current to properly control, within ranges not disturbing one pulse group-one drop transfer, at least one of the pulse frequency F_{low} of a low frequency pulse, a pulse peak time (Tₚ) (pulse width) and an average peak current IP_{avg}.

### BRIEF DESCRIPTION OF THE DRAWINGS

FIGS. 1A to 1D are, respectively, a schematic view showing the form of drop transfer and also a corresponding pulse current indicated by arrow;

FIG. 2 is a schematic view illustrating definitions of individual welding parameters used in the invention; and

FIG. 3 is a schematic view illustrating how pulsed arc welding is carried out,

### BEST MODE FOR CARRYING OUT THE INVENTION

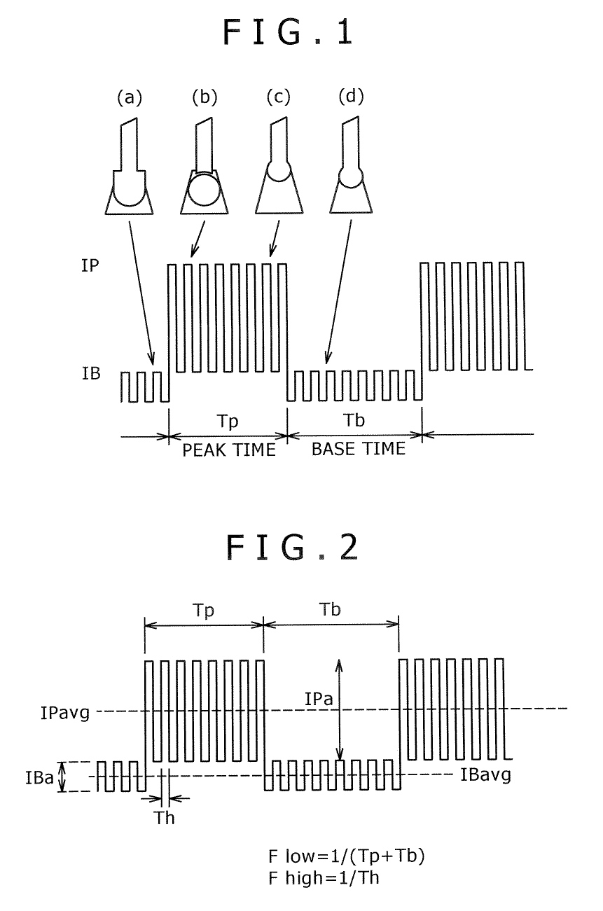

The invention is particularly described. FIGS. 1A to 1D schematically show the form of drop transfer along with a corresponding pulse current, respectively. The pulse current is such that as schematically shown in FIG. 2, a base current IB is passed, during a base time T_{b}, to an extent where no arc breakage takes place. In the course of the base time T_{b}, the current amplitude is indicated as IBₐ and the average base current is indicated as IB_{avg}. At the peak time Tₚ, a peak current IP is passed so as to ensure a satisfactory electromagnetic pinch force in the course of releasing a drop and stably form a drop that has an appropriate size in the course of drop formation. At the peak time Tₚ, the current amplitude is indicated as IPₐ and the average peak current is indicated as IP_{avg}.

The drop shown in FIG. 1A is one that is grown during a peak time Tₚ after release of a drop in a previous pulse cycle. Because a current abruptly decreases at the base time T_{b}, the push-up force is weakened, so that the drop is shaped so as to droop at a wire tip as is particularly shown in FIG. 1A. When going into a pulse peak time Tₚ, the drop is rapidly released while changing in shape as shown in FIG. 1B by the electromagnetic pinch force resulting from a peak current passing through the wire. After the release, another drop is grown at the step of FIG. 1C, followed by entering in a base time T_{b} and returning again to the state of FIG. 1A while forming a drop at the step of FIG. 1D.

As is particularly shown in FIGS. 1A to 1D, the invention is directed to a one pulse group-one drop transfer form synchronized with a low frequency pulse. In the practice of the invention, it is important to superimpose a high frequency pulse of 500 to 2000 Hz on the low frequency pulse. By the superimposition, an arc force capable of upwardly pushing the drop at the pulse peak time Tₚ and base time T_{b} becomes discontinuous. When comparing with the case where no high frequency pulse exists, the push-up force is greatly mitigated. Moreover, arc rigidity becomes extremely high, so that the drop and arc are likely to be axially symmetric, respectively. Since the drop and arc are both close to axial symmetry, a current path is in axial symmetry as well and an electromagnetic pinch force acting to release a drop is also likely to be in axial symmetry. In this condition, the release direction of a drop is very unlikely to be deviated from the wire direction. Because the electromagnetic pinch force is proportional to a square of current, it is enabled to release a drop at an earlier stage of the peak time over the case where no high frequency pulse is used, so that the drop can be finely particulated. Thus, there can be achieved a one pulse group-one drop transfer of very high reproducibility based on the finely particulated drop, and spatter and fume generation rates can be remarkably reduced. It is to be noted that the high frequency pulse being applied herein may be effective in either of a rectangular wave or a triangular wave, with no effect being lost even if a rectangular pulse is deformed by the influence of reactance.

Next, the reasons for definitions of numerical ranges of individual pulse parameters are illustrated. It will be noted that the respective pulse parameters are as defined in FIG. 2.

Average Peak Current IP_{avg}: 300 to 700 A

This parameter contributes greatly to ensuring a satisfactory electromagnetic pinch force in the course of releasing a drop and also to stable formation of a drop of an appropriate size at the step of forming the drop. If the average peak current IP_{avg} is smaller than 300 A, the electromagnetic pinch force becomes so low that the drop cannot release until after conversion into a bulky mass, thus resulting in deviation from one pulse group-one drop transfer. The contacts of the drop of a bulky mass with a base metal causes spatter and fume to be generated in large amounts. In contrast, if the average peak current IP_{avg} exceeds 700 A, the arc force, with which a drop is pushed up, becomes so intense that not only a difficulty is involved in regular drop release, but also one pulse group-n drops transfer is caused owing to an increasing amount of the melt at the peak time. In addition, there arises a problem in that apparatus weight and costs increase. It will be noted that a preferred range of the average peak current IP_{avg} is at 400 to 600 A.

Average Base Current IB_{avg}: 50 to 300 A

This parameter contributes greatly to stably shaping or dressing a drop without causing arc breakage in the course of drop shaping. If the average base current is smaller than 50 A, arc breakage and short-circuiting are liable to occur. When the average base current IB_{avg} exceeds 300 A, the arc force contributing to drop formation becomes so great and a melt at the base time T_{b} becomes so excessive that the resulting drop fluctuates and stable drop formation cannot be made.

Pulse Peak Time Tₚ (Pulse Width): 3 to 25 ms

Like the average peak current IP_{avg}, this parameter contributes greatly to ensuring a satisfactory electromagnetic pinch force in the course of releasing a drop and also to stable formation of a drop of an appropriate size at the step of forming the drop. If the pulse peak time Tₚ is less than 3 ms, release and satisfactory growth of a drop cannot be possible, resulting in an n-pulse group-one drop transfer to disturb the regularity of drop transfer. On the other hand, when the pulse peak time Tₚ exceeds 25 ms, a drop that is formed after drop release is grown in excess, so that regularity of drop transfer is disturbed and thus, spatter and fume are caused to be generated in large amounts. It will be noted that a preferred pulse peak time Tₚ is in the range of 5 to 15 ms.

Base Time T_{b}: 5 to 30 ms

Like IB_{avg}, this parameter contributes greatly to stable formation of a drop without arc breakage in the course of drop shaping. If the base time T_{b} is less than 5 ms, the drop cannot be shaped in a satisfactory manner, thus leading to a variation in release direction of the drop. On the other hand, when the base time T_{b} exceeds 30 ms, the amount of a melt becomes excessive at the base time T_{b} and thus, short-circuiting between the drop and the melt pond is apt to occur, thereby disturbing the regularity of drop transfer. It will be noted that a preferred base time T_{b} is in the range of 5 to 15 ms.

Pulse Frequency F_{low} of a Low Frequency Pulse: 30 to 100 Hz

This parameter contributes greatly to the size of a drop per pulse and a synchronization rate of the pulse and the drop transfer. If the pulse frequency F_{low} of a low frequency pulse is smaller than 30 Hz, a drop per unit pulse group becomes too large in size, so that the short-circuiting between the drop and a drop pond is liable to occur. On the other hand, when the pulse frequency F_{low} of a low frequency exceeds 100 Hz, one pulse group-one drop transfer cannot be realized, resulting in a drop transfer form not synchronized with pulse. It will be noted that a preferred range of the F_{low} is at 30 to 70 Hz.

Pulse frequency F_{high} of a High Frequency Pulse: 500 to 2000 Hz

This parameter contributes greatly to mitigation of an arc force that acts to upwardly push a drop during the pulse peak time Tₚ and base time T_{b} and also to rigidity of the arc. If the pulse frequency F_{high} of a high frequency pulse is smaller than 500 Hz, no effect of mitigating the arc force is expected, under which vibrations of a drop become so great that stable growth and shaping of the drop is not possible. When the pulse frequency F_{high} of a high frequency pulse exceeds 2000 Hz, the effect of applying the high frequency pulse is so lessened that the push-up force of the arc increases, resulting in the unlikelihood of axial symmetry of drop and arc. It will be noted that a preferred range of F_{high} is at 800 to 1500 Hz.

Current Amplitude IPₐ at Peak Time Tₚ of a High Frequency Pulse: 50 to 600 A

This parameter contributes greatly to mitigation of an arc force that acts to upwardly push a drop during the pulse peak time Tₚ and also to rigidity of the arc. If the current amplitude Iₚ at the peak time Tₚ of a high frequency pulse is smaller than 50 A, no effect of applying a high frequency pulse is expected, no effect of mitigating an arc force is obtained, and rigidity of an arc is weak. On the other hand, when the current amplitude Iₚ at the peak time Tₚ exceeds 600 A, the arc force varies so greatly that not only a difficulty is involved in the growth of stable drop, but also an electromagnetic pinch force becomes too intense, thereby causing fine spatter to be generated from the drop and melt pond in large amounts.

Current Amplitude IBₐ at Base Time T_{b} of a High Frequency Pulse: 20 to 200 A

This parameter contributes greatly to mitigation of an arc force that acts to upwardly push a drop during the pulse base time T_{b} and also to rigidity of the arc, especially to an occurrence frequency of arc breakage. If the current amplitude IBₐ at the base time T_{b} of a high frequency pulse is smaller than 20 A, no effect of applying a high frequency pulse is expected, no effect of mitigating the arc force is obtained, and arc rigidity is so small that arc breakage frequently occurs. On the other hand, when the current amplitude exceeds 200 A, the arc force varies too greatly, so that a difficulty is involved in stable drop shaping.

Next, a composition for consuming electrode wire is illustrated. In the pulsed arc welding of the invention, the wire composition is not critical. A preferred composition is one indicated below. More particularly, the composition for consuming electrode wire comprises not more than 0.10 wt % of C, 0.20 to 1.0 wt % of S, 0.50 to 2.0 wt % of Mn, 0.05 to 0.40 wt % of Ti+Al+Zr and the balance being Fe and inevitable impurities. The reasons for the above compositional ranges are described below.

C: 0.10 Wt % or Less

C is an element that is important for ensuring strength of a weld metal. When the content exceeds 0.10 wt %, the resulting drop and melt pond deform and vibrate considerably, resulting in an increase in amount of spatter and fume. Accordingly, the content of C is not higher than 0.10 wt %.

Si: 0.20 to 1.0 Wt %

Si needs to be at least at 0.20 wt % for use as a deoxidizing agent. If the content of Si is less than 0.20 wt %, the viscosity of a drop becomes so low that the drop deforms irregularly owing to the arc force, resulting in increasing amounts of spatter and fume. On the other hand, when Si exceeds 1.0 wt %, slag increases in amount and the viscosity of a drop becomes too great, which may result in deviation from one pulse group-one drop transfer in some case. Accordingly, the content of Si ranges from 0.20 to 1.0 wt %.

Mn: 0.50 to 2.0 Wt %

Mn is an important element as a deoxidizing agent, like Si and should be at least at 0.50 wt %. If Mn is less than 0.50 wt %, the viscosity of a drop becomes so low that the drop is caused to be irregularly deformed owing to the arc force, thereby increasing spatter and fume. On the other hand, when Mn exceeds 2.0 wt %, wire drawability degrades at the time of manufacturing a welding wire and the viscosity of a drop becomes too great, which may result in the deviation from one pulse group-one drop transfer in some case. Accordingly, the content of Mn ranges from 0.50 to 2.0 wt %.

Ti+Al+Zr: 0.05 to 0.40 Wt %

Ti, Al and Zr are elements which are important as a deoxidizing agent and for ensuring strength of a weld metal. In this process, these elements are added so as to optimize the viscosity of a drop and bring about an effect of suppressing an unstable behavior. If the content of Ti+Al+Zr is less than 0.05 wt %, such effects as mentioned above become poor, increasing small-sized spatter in amount. On the other hand, if the content of Ti+Al+Zr exceeds 0.40 wt %, slag detachability and toughness of a weld metal degrade and the viscosity of a drop becomes so high that the transfer deviates from one pulse group-one drop transfer, resulting in an increase of spatter and fume. Accordingly, Ti+Al+Zr ranges from 0.05 to 0.40 wt % in total.

In the pulsed arc welding method of the invention, a consuming electrode wire should preferably be one wherein no copper is plated on the wire surface. No copper plating on the wire surface enables the surface tension to lower at a constricted portion of the drop, under which the drop is likely to release from the wire by means of an electromagnetic pinch force. Thus, very highly reproducible drop transfer can be realized.

Fundamental welding conditions on which the pulsed arc welding method of the invention has been presupposed include: wire diameter=0.6 to 1.6 mm; material to be welded=iron material; and distance between chip and base metal=10 to 45 mm although not limited to those conditions. Although the welding speed is not critical, it is recommended to use a welding speed at 20 to 10 cm/minute.

The invention is more particularly described by way of examples so as to evidence the effect of the invention. The results of tests are illustrated including examples within the scope of the invention along with comparative examples which are outside the scope of the invention.

### EXAMPLE 1

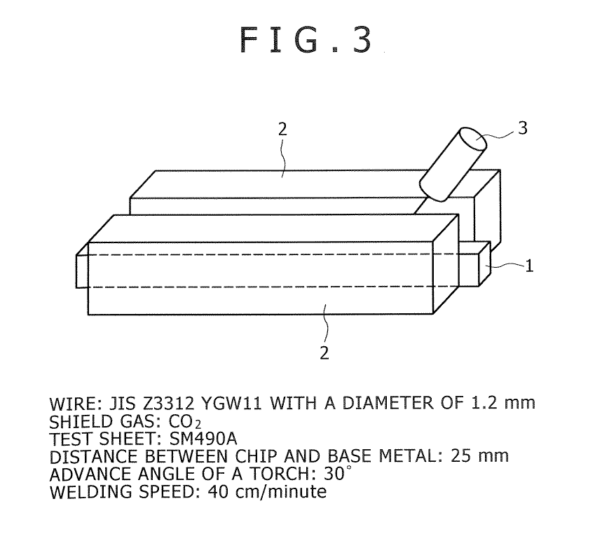

Using the welding conditions indicated below and pulse parameter values indicated in Table 1, pulsed arc welding was carried out using carbon dioxide gas as a shield gas to measure a generation rate of spatter. More particularly, as shown in FIG. 3, a welding base metal 1 was sandwiched between a pair of copper collector boxes 2 in such a way that openings of the respective collector boxes were in face-to-face relation with the base metal 1, under which arc welding was carried out by use of a welding wire chip fed from a torch 3 to collect spatter within the copper collector boxes 2. The generation rate of fume was measured according to the method described in JIS Z 3930.
Wire: YGW 11 with a diameter of 1.2 mm of JIS Z3312
Carbon dioxide gas: CO₂
Test sheet: SM490A
Distance between chip and base metal: 25 mm
Welding speed: 40 cm/minute

The results of the measurement of spatter and fume generation rates are shown in Table 1 below. It will be noted that in Table 1, evaluation was made in such a way that those examples or comparative examples wherein the spatter generation rate was at 4.0 g/minute or less and the fume generation rate was at 400 mg/minute were assessed as good (◯), and those wherein the spatter generation rate exceeded 4.0 g/minute or the fume generation rate exceeded 400 mg/minute were assessed as poor (X).

TABLE 1

| | | | | | | | | | | Amount of | Amount of | |
|---|---|---|---|---|---|---|---|---|---|---|---|---|
| | | | | | | | | | | spatter | fume | |
| No. | | IP_{avg} | IB_{avg} | TP | TB | F_{low} | F_{high} | IPₐ | IBₐ | (g/minute) | (g/minute) | Evaluation |
| Prior art method | | Wire feed rate: 15.5 m/minute, welding current: 320 A, | | | | | | | | 7.5 | 550 | X |
| | | welding voltage: 36 V | | | | | | | | | | |
| Example | 1 | 320 | 210 | 10 | 13 | 43.5 | 800 | 300 | 150 | 2.5 | 330 | ◯ |
| | 2 | 500 | 180 | 10 | 7 | 58.8 | 800 | 250 | 100 | 1.8 | 294 | ◯ |
| | 3 | 680 | 150 | 5 | 10 | 66.7 | 1000 | 70 | 70 | 3.2 | 384 | ◯ |
| | 4 | 450 | 50 | 12 | 7 | 52.6 | 600 | 200 | 30 | 2.1 | 312 | ◯ |
| | 5 | 530 | 270 | 9 | 12 | 47.6 | 1500 | 250 | 150 | 3.5 | 376 | ◯ |
| | 6 | 600 | 100 | 4 | 20 | 41.7 | 1200 | 400 | 80 | 2.2 | 321 | ◯ |
| | 7 | 490 | 150 | 9 | 9 | 55.6 | 1000 | 200 | 100 | 1.7 | 284 | ◯ |
| | 8 | 400 | 70 | 24 | 8 | 31.3 | 900 | 110 | 50 | 2.0 | 316 | ◯ |
| | 9 | 500 | 140 | 8 | 5 | 76.9 | 700 | 150 | 100 | 3.3 | 372 | ◯ |
| | 10 | 540 | 100 | 8 | 10 | 55.6 | 1200 | 270 | 80 | 1.6 | 287 | ◯ |
| | 11 | 550 | 120 | 6 | 25 | 32.3 | 1600 | 450 | 80 | 2.4 | 326 | ◯ |
| | 12 | 350 | 60 | 15 | 18 | 30.3 | 1800 | 300 | 30 | 2.1 | 314 | ◯ |
| | 13 | 430 | 180 | 5 | 5 | 100.0 | 1300 | 90 | 120 | 2.8 | 355 | ◯ |
| | 14 | 500 | 200 | 12 | 14 | 38.5 | 500 | 230 | 100 | 3.2 | 384 | ◯ |
| | 15 | 480 | 230 | 7 | 7 | 71.4 | 2000 | 180 | 60 | 2.8 | 340 | ◯ |
| | 16 | 570 | 130 | 14 | 10 | 41.7 | 1100 | 60 | 100 | 3.7 | 391 | ◯ |
| | 17 | 620 | 130 | 8 | 9 | 58.8 | 1400 | 500 | 90 | 3.4 | 377 | ◯ |
| | 18 | 650 | 80 | 11 | 20 | 32.3 | 1700 | 350 | 20 | 1.6 | 301 | ◯ |
| | 19 | 380 | 250 | 8 | 5 | 76.9 | 1900 | 180 | 200 | 1.6 | 315 | ◯ |
| Comparative | 20 | 280 | 230 | 13 | 8 | 47.6 | 800 | 200 | 120 | 4.5 | 491 | X |
| Example | 21 | 720 | 150 | 5 | 10 | 66.7 | 1000 | 550 | 50 | 12.3 | 693 | X |
| | 22 | 450 | 40 | 10 | 10 | 50.0 | 700 | 300 | 30 | 5.3 | 538 | X |
| | 23 | 350 | 320 | 14 | 8 | 45.5 | 1200 | 270 | 180 | 6.1 | 597 | X |
| | 24 | 550 | 100 | 2 | 12 | 71.4 | 1800 | 400 | 60 | 6.9 | 625 | X |
| | 25 | 420 | 150 | 26 | 5 | 32.3 | 1500 | 280 | 70 | 10.5 | 681 | X |
| | 26 | 500 | 130 | 10 | 3 | 76.9 | 1000 | 350 | 70 | 14.3 | 689 | X |
| | 27 | 600 | 70 | 5 | 31 | 32.3 | 1200 | 500 | 40 | 4.4 | 483 | X |
| | 28 | 500 | 200 | 10 | 15 | 28.6 | 1300 | 180 | 190 | 4.1 | 455 | X |
| | 29 | 620 | 180 | 4 | 5 | 111.1 | 600 | 160 | 150 | 9.7 | 675 | X |
| | 30 | 330 | 90 | 7 | 20 | 38.5 | 480 | 70 | 60 | 5.9 | 545 | X |
| | 31 | 400 | 180 | 9 | 11 | 50.0 | 2100 | 90 | 110 | 4.5 | 485 | X |
| | 32 | 470 | 220 | 12 | 9 | 47.6 | 900 | 30 | 100 | 10.8 | 693 | X |
| | 33 | 670 | 60 | 15 | 16 | 32.3 | 1800 | 620 | 30 | 13.8 | 687 | X |
| | 34 | 650 | 280 | 20 | 6 | 38.5 | 1900 | 120 | 10 | 12.5 | 688 | X |
| | 35 | 570 | 250 | 11 | 18 | 34.5 | 1600 | 160 | 220 | 14.9 | 692 | X |

As will be apparent from Table 1, Examples 1 to 19 are within the scope of the invention with respect to the welding parameters defined in an aspect of the invention. In these examples, the amounts of spatter are all less than 4.0 g/minute and the amounts of fume are less than 400 mg/minute in all cases.

In contrast, Comparative Examples 20 to 35 are outside the scope of the invention and are all poor with respect to the evaluation thereof. This is particularly described below. In Comparative Example No. 20 wherein IP_{avg} is smaller than the lower limit defined in the present invention, a drop is formed as a bulky mass and cannot be released, thereby resulting in deviation from one pulse group-one drop transfer and increasing spatter owing to irregular short-circuiting. Comparative Example 21 is such that IP_{avg} exceeds the upper limit of the invention, so that the arc force serving to push up a drop at the peak time becomes too high, making it difficult to realize regular drop transfer and thus resulting in an increase in amount of spatter. In Comparative Example 22 wherein IB_{avg} is smaller than the lower limit of the invention, arc breakage and short-circuiting are liable to occur, resulting in an increase in amount of spatter. In Comparative Example 23 wherein IB_{avg} exceeds the upper limit, a difficulty is involved in stable formation of a drop at the base time, so that the drop undergoes vibrations and deformation prior to the application at the peak time. This entails irregularity of drop transfer, thereby increasing spatter. In Comparative Example 24 wherein Tₚ is lower than the lower limit, the release and growth of a drop becomes unsatisfactory, which results in n-pulse group-one drop transfer, thereby increasing spatter. In Comparative Example 25 wherein Tₚ is higher than the upper limit, not only a next drop after release of a drop is grown up excessively, but also one pulse group-n-drop transfer is liable to occur wherein drop transfer is again repeated at the latter half of the pulse peak time, thereby increasing spatter. In Comparative Example 26 wherein T_{b} is smaller than the lower limit, a drop cannot be shaped satisfactorily during the base time, so that the release direction of a drop deviates from the wire direction, thereby increasing spatter. In Comparative Example 27 wherein T_{b} exceeds the upper limit, a melt at the base time is formed in excess and thus, short-circuiting is apt to occur during the base time, thereby increasing spatter. In Comparative Example 28 wherein F_{low} is smaller than the lower limit, a drop per one pulse group becomes too large in size, under which irregular short-circuiting is liable to occur through the contact between the drop and the melt pond, thereby increasing spatter. In Comparative Example 29 wherein F_{low} exceeds the upper limit, one pulse group-one drop transfer is disenabled, thereby increasing spatter. In Comparative Example 30 wherein F_{high} is lower than the lower limit, the resulting drop vibrates greatly and thus, a difficulty is involved in stable growth and formation of a drop, thereby increasing spatter. In Comparative Example 31 wherein F_{high} exceeds the upper limit, the push-up force increases even if a high frequency pulse is applied to, under which a drop is irregularly raised, resulting in an increase of spatter. In Comparative Example 32 wherein IPₐ is smaller than the lower limit, no effect of application of a high frequency pulse is obtained. Accordingly, a drop at the peak time irregularly vibrates and deforms, thereby increasing spatter. In Comparative Example 33 wherein IPₐ exceeds the upper limit, the arc force influencing on a drop at the peak time varies excessively, making it difficulty to stably grow the drop. In Comparative Example 34 wherein IBₐ is smaller than the lower limit, no effect of application of a high frequency pulse is obtained and thus, a drop at the base time irregularly vibrates and deforms, thereby increasing spatter. In Comparative Example 35 wherein IBₐ exceeds the upper limit, the arc force acting on a drop at the base time greatly varies and thus stable shaping of the drop is difficult, thereby increasing spatter.

### EXAMPLE 2

Pulsed arc welding was performed using the following welding conditions, consuming electrode wires having compositions indicated in Table 2 and carbon dioxide gas as a shield gas, and the results of measurement of spatter and fume generation rates are illustrated. The spatter collection method and the method of measuring an amount of fume are as described before, respectively. In Table 2, evaluation was made in such a way that those examples or comparative examples wherein the spatter generation rate is at 2.5 g/minute or less and the fume generation rate is at 350 mg/minute or less is assessed as good (◯) and those wherein the spatter generation rate exceeds 2.5 g/minute or the fume generation rate exceeds 350 mg/minute is assessed as poor (X).
Size of wire: 1.2 mm in diameter
Carbon dioxide gas: CO₂
Test sheet: SM490A
Distance between chip and base metal: 25 mm
Angle of advance of torch: 30°
Welding speed: 40 cm/minute
Wire feed speed: 15.5 m/minute
IP_{avg}: 500 A
IB_{avg}: 200 A
Tₚ: 9 ms
T_{b}: 10 ms
F_{low}: 50 Hz
F_{high}: 1000 Hz
IPₐ: 300 A

IBₐ: 100 A

TABLE 2

| | | | | | | | | Ti + | | | | |
|---|---|---|---|---|---|---|---|---|---|---|---|---|
| | | | | | | | | Al + | | Amount of | Amount of | |
| | | C | Si | Mn | Ti | Al | Zr | Zr | Copper | spatter | fume | |
| No. | | wt % | wt % | wt % | wt % | wt % | wt % | wt % | plated | (g/minute) | (g/minute) | Evaluation |
| Example | 36 | 0.05 | 0.60 | 1.25 | 0.1 | — | 0.05 | 0.15 | yes | 1.9 | 309 | ◯ |
| | 37 | 0.05 | 0.62 | 1.23 | 0.05 | 0.1 | — | 0.15 | no | 1.6 | 287 | ◯ |
| | 38 | 0.07 | 0.22 | 1.15 | 0.05 | 0.04 | — | 0.09 | yes | 2.2 | 331 | ◯ |
| | 39 | 0.05 | 0.90 | 1.33 | 0.05 | — | 0.1 | 0.15 | yes | 1.4 | 282 | ◯ |
| | 40 | 0.05 | 0.88 | 1.35 | 0.1 | 0.05 | — | 0.15 | no | 1.2 | 285 | ◯ |
| | 41 | 0.08 | 0.40 | 0.55 | — | 0.05 | 0.04 | 0.08 | yes | 1.6 | 275 | ◯ |
| | 42 | 0.04 | 0.82 | 1.92 | 0.1 | 0.04 | 0.04 | 0.18 | yes | 1.5 | 293 | ◯ |
| | 43 | 0.03 | 0.75 | 1.22 | 0.05 | — | — | 0.05 | yes | 2.1 | 308 | ◯ |
| | 44 | 0.03 | 0.72 | 1.20 | — | 0.05 | — | 0.05 | no | 1.5 | 280 | ◯ |
| | 45 | 0.04 | 0.65 | 1.55 | 0.1 | — | 0.1 | 0.20 | no | 1.8 | 291 | ◯ |
| | 46 | 0.08 | 0.78 | 1.36 | 0.1 | 0.01 | 0.15 | 0.35 | yes | 2.2 | 311 | ◯ |
| Comparative | 47 | 0.11 | 0.60 | 1.25 | — | 0.1 | 0.05 | 0.15 | yes | 2.8 | 375 | X |
| Example | 48 | 0.07 | 0.18 | 1.15 | 0.05 | 0.04 | — | 0.09 | yes | 2.6 | 361 | X |
| | 49 | 0.05 | 1.10 | 1.33 | 0.1 | — | 0.05 | 0.15 | yes | 3.2 | 384 | X |
| | 50 | 0.05 | 1.09 | 1.35 | 0.05 | — | 0.1 | 0.15 | no | 2.8 | 365 | X |
| | 51 | 0.05 | 0.40 | 0.45 | 0.04 | 0.04 | — | 0.08 | yes | 3.7 | 452 | X |
| | 52 | 0.06 | 0.82 | 2.05 | — | 0.1 | 0.08 | 0.18 | yes | 2.9 | 369 | X |
| | 53 | 0.07 | 0.80 | 2.13 | 0.07 | 0.05 | 0.05 | 0.17 | no | 2.7 | 357 | X |
| | 54 | 0.05 | 0.75 | 1.22 | — | — | — | — | yes | 4.2 | 442 | X |
| | 55 | 0.05 | 0.75 | 1.22 | 0.03 | — | — | 0.03 | no | 3.5 | 411 | X |
| | 56 | 0.07 | 0.65 | 1.55 | 0.2 | 0.15 | 0.1 | 0.45 | yes | 3.2 | 395 | X |

Examples 36 to 46 in Table 2 make use of consuming electrode wires that satisfy the requirements defined in an aspect of the invention, under which welding is carrier out in a satisfactory manner, with amounts of spatter and fume being low, respectively. Especially, comparisons between Examples 36 and 37, Examples 39 and 40 and Examples 43 and 44 reveals that when using wires having similar compositions, respectively, the case where no copper plating is performed is lower with respect to the amount of spatter. In this way, no copper plating enables the surface tension to be lowered at a constricted portion of a drop, thus permitting the drop to be more readily released from the wire owing to the electromagnetic pinch force. Accordingly, drop transfer of very high reproducibility is enabled, and spatter can be further reduced in amount.

On the other hand, Comparative Examples 47 to 56 are outside the scope of the invention defined in an aspect of the invention with respect to the composition of a consuming electrode welding wire, in which amounts of spatter and fume are both large. More particularly, Comparative Example 47 is such that because C in the wire exceeds the upper limit of the invention, a drop and melt pond deform and vibrate violently, thereby increasing spatter. In Comparative Example 48, because Si in the wire is less than the lower limit, the drop becomes so low in viscosity that the drops suffers irregular deformation owing to the arc force, thereby increasing spatter. In Comparative Examples 49, 50, the content of Si exceeds the upper limit, so that the resulting drop becomes too high in viscosity, resulting in deviation from one pulse group-one drop transfer and increasing spatter. In Comparative Example 51 wherein Mn in the wire is less than the lower limit, the resulting drop becomes so low in viscosity that the drop irregularly deforms by means of the arc force, thereby increasing spatter. In Comparative Examples 52, 53 wherein Mn in the wire exceeds the upper limit, the resulting drop becomes too high in viscosity, thereby resulting in deviation from one pulse group-one drop transfer and increasing spatter. In Comparative Examples 54, 55 wherein Ti+Al+Zr in the wire is less than the lower limit, the drop suffers irregular deformation by means of the arc force, thereby increasing spatter. In Comparative Example 56 wherein Ti+Al+Zr in the wire exceeds the upper limit, the drop becomes to high in viscosity, resulting in deviation from one pulse group-one drop transfer and increasing spatter.

It will be noted that the conditions of evaluation as “o” become server in Example 2 (Table 3) than in Example 1 (Table 1). More particularly, the example samples in Table 2 are those that satisfy more preferred conditions. In this manner, the conditions for wire composition in the pulsed arc welding method of the invention indicate those conditions capable of yielding preferred wires, i.e. a preferred selection.

What is claimed is:

1. A pulsed arc welding method wherein carbon dioxide gas or a mixed gas made mainly of carbon dioxide gas as a shield gas is used, a low frequency pulse of 30 to 100 Hz is continuously generated while superimposing a high frequency pulse with a pulse frequency ranging from 500 to 2000 Hz on the low frequency pulse, and the following welding parameter conditions (a) to (h) are satisfied:
(a) average peak current IP_{avg}=300 to 700 A;
(b) average base current IB_{avg}=50 to 300 A;
(c) pulse peak time Tₚ=3 to 25 ms;
(d) base time T_{b}=5 to 30 ms;
(e) pulse frequency F_{low} of a low frequency pulse=30 to 100 Hz;
(f) pulse frequency F_{high} of a high frequency pulse=500 to 2000 Hz;
(g) current amplitude IPₐ at a peak time of a high frequency pulse=50 to 600 A; and
(h) current amplitude IBₐ at a base time of a high frequency pulse=20 to 200 A.

2. The pulsed arc welding method according to claim 1, wherein the following welding conditions (i) to (m) are satisfied:
(i) average peak current IP_{avg}=400 to 600 A;
(j) pulse peak time Tₚ=5 to 15 ms;
(k) base time T_{b}=5 to 15 ms;
(l) pulse frequency F_{low} of a low frequency pulse=30 to 70 Hz; and
(m) pulse frequency F_{high} of a high frequency pulse=800 to 1500 Hz.

3. The pulsed arc welding according to claim 1, wherein a consuming electrode wire used is made of not more than 0.1 wt % of C, 0.20 to 1.0 wt % of Si, 0.50 to 2.0 wt % of Mn, and 0.05 to 0.40 wt %, in total, of Ti+Al+Zr with the balance being Fe and inevitable impurities.

4. The pulsed arc welding according to claim 1, wherein a consuming electrode wire used has surfaces not plated with copper.
